(19) United States
(12) Patent Application Publication
(10) Pub. No.: US 2007/0294583 A1
(43) Pub. Date: Dec. 20, 2007

(54) Device and Method for Analyzing Embedded Systems for Safety-Critical Computer Systems in Motor Vehicles

(75) Inventors: Adrian Traskov, Steinbach (DE); Burkart Voss, Dorndorf-Steudnitz (DE); Heiko Michel, Frankfurt (DE)

Correspondence Address: CONTINENTAL TEVES, INC., ONE CONTINENTAL DRIVE, AUBURN HILLLS, MI, 48326-1581, US

(73) Assignee: Continental Teves AG & Co. OHG, Frankfurt (DE)

(21) Appl. No.: 10/588,873

(22) PCT Filed: May 13, 2004
(86) PCT No.: PCT/EP04/50803

§ 371 Date: Jun. 21, 2007

(30) Foreign Application Priority Data
Feb. 9, 2004 (DE) 10 2004 006 437.7

(51) Int. Cl. G06F 11/00

(52) U.S. Cl. 714/37

(57) ABSTRACT

The invention describes an analyzing device for an embedded system (9), which has at least one CPU (1), at least one CPU bus (2), and at least one memory (3). The device includes a communication module (4) for the input or output of analysis data using a test interface (5), which, in addition to control lines, includes at least one group of data lines. The data words and the address words are transmitted alternately or in other succession by way of the test interface. This achieves the advantage of error detection while using few basic cycles of the CPU.

### BACKGROUND OF THE INVENTION

The present invention relates to an analyzing device for an embedded system (9), which comprises at least one CPU (1), optionally at least one CPU bus (2), and at least one memory (3), including at least one communication module (4) for the input or output of analysis data using a test interface (5), wherein the test interface, in addition to control lines, includes at least one group of data lines transmitting data words and address words alternately or in other succession, and the information whether data words or address words are transmitted is transmitted by way of at least one control line so that the content and access operations during the operation time to the describable internal memory as well as I/O access operations of the embedded system can be monitored and/or logged practically without using basic cycles of the CPU (1). The present invention also relates to a method for the analysis of an embedded system with a test interface. The method includes in that for the transmission of data through the test interface, a data transmission protocol is used in which data is transmitted in several groups of addresses and data.

To successfully develop software for embedded systems, it is general practice to provide devices that allow error detection during the operation time (debugging). According to a known concept for error detection during the operation time (debugging) in embedded systems, a connection to an external analysis system is established by way of a so-called JTAG-interface (Joint Test Action Group, IEEE Standard 1149.1-1990, ‘IEEE Standard Test Access Port and Boundary Scan Architecture’, Institute of Electrical and Electronics Engineers Inc., New York, USA, 1990). With the aid of this analysis interface, it is possible to perform different testing operations by a ‘Boundary-Scan’ test method, such as single-step processing of the processor (single-stepping), setting of break points (break points) and setting of so-called ‘watch points’. Admittedly, these per se known auxiliary means for error detection render it principally possible to follow the execution of the program including the state of selected values of variables, however, the system in operation must usually be stopped to do so. It is practically not possible though to stop the microcomputer to be analyzed in the controlling tasks in an electronically controlled motor vehicle brake systems, which are preferred according to the invention.

For error detection in embedded systems, it is further known in the application in motor vehicle brake systems to employ a so-called trace-interface, which uses a so-called ‘bond out’ chip for the real time analysis in order to allow the relay of all relevant CPU bus signals (address signals, data signals, and check bits) by way of housing pins e.g. to an external logic analysis device. A ‘bond out’ chip concerns a microcontroller (MCU) in which the processor bus (data signals, address signals, check bits) are bonded from the housing interior to the outside.

This method for error analysis can no longer be used due to high speed requirements as regards the high system frequencies far in excess of 100 megahertz being usual in nowadays embedded systems with rapid, processor-side intermediate memories (caches). A real time output of relatively large data memories (for example of a magnitude of more than 100 kilobyte) is usually impossible due to the system frequencies being predetermined on account of the technology employed and the band width resulting therefrom. One possibility of creating the band width that is necessary for real-time data transmission would be a parallel output of the data being transmitted. The electric connecting pins available for this purpose in a technical realization are, however, usually limited, not least for cost reasons, to a certain predefined number.

In view of the above, there is still the object of providing an analyzing device for embedded systems, which can be employed even in the rapid embedded systems that are customary nowadays.

### SUMMARY OF THE INVENTION

To solve this object, the older international patent application PCT/EP 03/12630 that is not published discloses an analyzing device for an embedded system, which comprises a CPU, a CPU bus, and a memory. The analyzing device applied for patent includes at least one communication module for the input or output of analysis data by way of a test interface. The said analyzing device is so configured that the internal memory and I/O access operations of the integrated system can be monitored and/or logged with the communication module, without using basic cycles of the CPU.

This approach is based on the following reflections: On the one hand, the internal system state of an integrated system can be described or analyzed by its current data memory contents (RAM). It ensues therefrom that in case this memory contents in real time can be copied into an external data memory, there is a possibility of further processing and evaluating the system state by a subsequent evaluating unit in the external data memory.

To solve the above-mentioned problem, the invention describes a new analyzing device for an embedded system (9), which comprises at least one CPU (1), optionally at least one CPU bus (2), and at least one memory (3), including at least one communication module (4) for the input or output of analysis data using a test interface (5), wherein the test interface, in addition to control lines, includes at least one group of data lines transmitting data words and address words alternately or in other succession, and the information whether data words or address words are transmitted is transmitted by way of at least one control line so that the content and access operations during the operation time to the describable internal memory as well as I/O access operations of the embedded system can be monitored and/or logged practically without using basic cycles of the CPU (1).

The disclosed analyzing device e.g. allows writing a copy of the internal system state in an external memory in real time. This way, the proper function of the embedded system can be tested from outside in a particularly simple manner.

The analyzing device disclosed and the method disclosed achieves the advantage of low consumption of basic cycles used for the analysis.

In this arrangement, the analyzing device is preferably a component of an embedded system, which is used in particular in electronic control devices for motor vehicle brake systems. Therefore, the communication module is preferably integrated in the embedded system. This system moreover accommodates the essential components of the system such as one or more CPUs and memories, which are especially of a partly or fully redundant design. This enhances the safety of operation of the embedded system.

Favorably, data is not logged in the way that the entire memory content or the content of a whole memory range is transmitted. Instead, only the changes of the memory, especially all write access operations of the CPU and/or the periphery, are transmitted. This allows reducing the necessary band width for data output.

Besides, the system preferably comprises a means for the direct data output by the CPU. Apart from this means for the direct data output, there is especially provision of means for an automatic replication of the data in the background by way of the analysis module. This achieves the advantage of an enhanced flexibility in the data output.

Especially for these cases of application, the invention discloses the described universal data input and data output module, which is designed in such a fashion that an embedded system allows performing a data exchange in real time without having to stop the system, not even for a brief interval (non-intrusive).

Compared to the software error-detection devices known from the state of the art, the hardware analyzing device of the invention is advantageous because the dynamic system behavior, in particular of the control variables, can be followed in the development of control algorithms, e.g. for motor vehicle brake systems. Further, it is favorable that a data input into the embedded system can be performed for the application of an embedded system in a hardware-in-the-loop simulator or in a rapid-prototyping system.

The invention further relates to an embedded system, which comprises at least one central processing unit and a memory, this system being characterized by an analyzing device that is described in the above. Therefore, the invention also relates to the use of an analyzing device of this type in these embedded systems.

Apart from the embedded system, the solution of the invention also comprises an integrated microprocessor system for motor vehicles with at least two processor cores (CPUs) which is characterized in that a complete analyzing device, as has been described hereinabove, is assigned to at least one of the processor cores contained therein. Further, the invention concerns the use of the above analyzing device in an integrated microprocessor system of this type.

More particularly, an incomplete analyzing device is associated with another processor core in this microprocessor system and has a reduced scope of functions compared to the complete analyzing device described hereinabove.

In the microprocessor system described above, there is preferably provision of a first signal connection to stop the first core and another redundant signal connection to stop the additional redundant processor core.

In this arrangement, especially the first signal connection links to the first analyzing device and the second redundant signal connection connects to the incomplete analyzing device.

In the above described microprocessor system, the reduction of the scope of functions preferably involves that the buffer store provided in the analyzing device has a smaller word width.

Further reduction of the scope of functions is favorably achieved in that the test interface does not extend to the outside or does not exist.

Also, the invention relates to a method for the analysis of an embedded system described hereinabove with an analyzing device, as has been described before, wherein a data transmission protocol is used for the transmission of data by way of the test interface and data is transmitted in several groups of addresses and data.

According to a favorable method step, initially
the memory content or a correspondingly assessable information of the embedded system is copied in real time completely or partly into an external memory, with the data being buffered in particular before this action, and/or
the memory content of the external memory or any correspondingly assessable information about the memory content of the external memory is copied in real time completely or partly into a memory of the embedded system, with the data being buffered in particular before this action.

The external memory is preferably used for the transmission of data for typical debugging applications.

The method is advantageous because the processing speed of the embedded system is not reduced due to the measures for error detection performed by the hardware elements. This renders real time processing of the data possible even during the debugging operation.

Favorably, the analyzing device of the invention cannot only be used for error detection, but also for the development of motor-vehicle-related software algorithms or control algorithms because monitoring of the variables (control variables) permits a particularly simple review and optimization of the control quality.

The method of the invention preferably comprises likewise steps for the real-time output of the complete data memory content.

Further, a mode can suitably be provided in the embedded system in which all write and/or read access operations of the CPU are rerouted to the communication module.

In addition, the embedded system can comprise another preferred mode in which only either the write access operations or the read access operations of the CPU are rerouted to the communication module, while the remaining access operations of the CPU to the memory are actively logged by the CPU into the external memory.

Further preferred embodiments can be seen in the sub claims and the following description of the Figures.

Hereinbelow the invention will be explained in detail by way of examples.

### BRIEF DESCRIPTION OF THE DRAWINGS

In the drawings:

FIG. 1 shows an embedded system 9 with an analyzing device 4 according to the invention;

FIG. 2 shows examples for a possible pin allocation and a timing diagram for a test interface 5, and

FIG. 3 shows an example for a redundant, surface-optimized safe microprocessor system with analysis port.

### DETAILED DESCRIPTION OF THE DRAWINGS

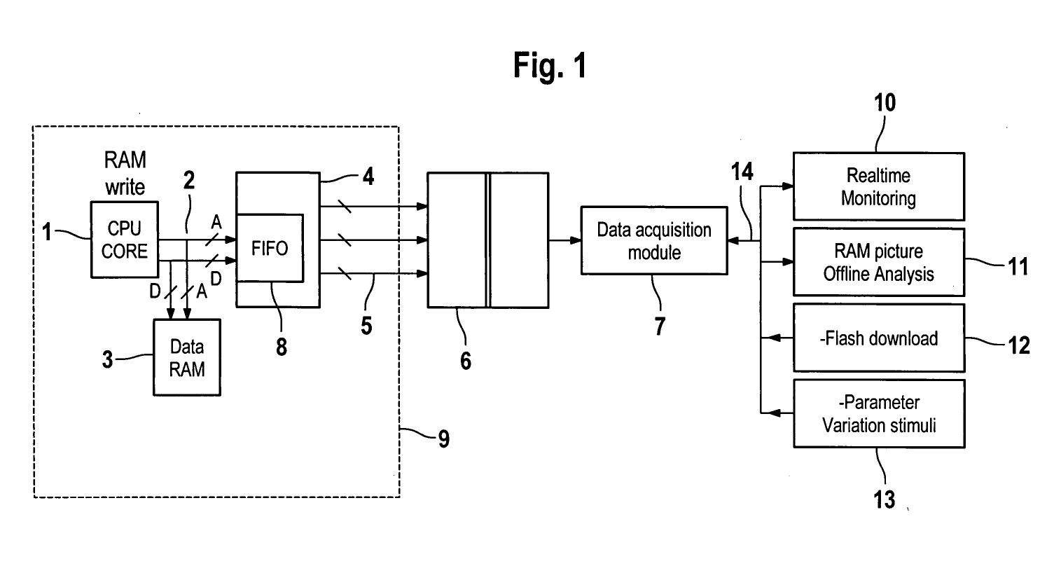

Embedded system 9 in FIG. 1 comprises one or more CPUs 1, one or more erasable data memories 3 (RAM), an analyzing device 4, and a test interface 5. To simplify the block diagram, further customary function elements of the embedded system such as ROM, clock generation means, IO, etc. are not drawn.

Analyzing device 4 includes three function modes, which will be described in the following. In the first function mode, all write access operations of the CPU 1 to data memory 3 are written automatically via CPU bus 2 by the proposed extended data output/input unit 4 by means of a controller or a trace logic 22, 23 contained therein by way of test interface 5 to the external data memory 6. CPU bus 2 may be omitted in an alternative example, when the embedded system has a RAM that is tightly coupled to the CPU (tightly coupled RAM); and in this case the information can be read out via a core-specific interface. Thus, the analyzing device is able to likewise read all write access operations of the CPU 1 to data memory 3. Therefore, the controller contained in unit 4 comprises at least the same band width as the employed memory 3, and also receives checking and address information in addition to data by way of internal data lines. Corresponding to a preferred embodiment of the method, the controller is thus able to follow specially selected address ranges and/or specially selected data types for the analysis. For tapping the data and the data transfer, CPU 1 consequently is not required to execute additional commands. Analyzing device 4 further comprises a FIFO memory 8 (First In/First Out) being arranged in the data output unit 4. This memory 8 ensures a temporal buffering of the tapped data. It is this way possible to output access operations to test interface 5, the band width of which is higher for a short time than the band width of the test interface 5. This can be the case e.g. in access operations where a cache line or a CPU register dump is re-written upon function entry.

External data memory 6 is preferably designed as a memory with dual data interface (dual port) and typically contains a precise image of the memory ranges monitored in RAM 3 or of the entire memory content of RAM 3. Memory 6 may also concern a central core memory, which stores the incoming data flow for a later (offline) analysis.

Test interface 5 is designed as a modified parallel interface having the special feature that data lines are provided in addition to control lines and can alternately transmit address information and data.

Analyzing device 4 logs all read access operations of CPU 1 to the data memory in the second function mode. This mode largely corresponds to the first function mode, however, with the following differences: All read access operations are output automatically using test interface 5. Analyzing device 4 registers all operations such a read cycles, write cycles, etc. which are carried out by the embedded system (read for control). CPU 1 actively performs a dump, which entails an insignificant tolerable loss in operation time though.

In the analyzing device operating in the second function mode, CPU 1 reads the data memory content into the CPU registers. Parallel hereto, the analyzing device 4 automatically outputs the corresponding data, that means, the analysis does not need an explicit write cycle for the data output.

There is a direct writing to the data output unit or a direct reading from the data output unit in the third function mode. The third function mode corresponds basically to the first function mode, except for the fact that data is output actively by the CPU 1 externally to the analyzing unit 4, or is read actively from there, with the result that additional basic cycles are needed, however.

Using module 7, the analysis unit can transmit data from the external memory 6 to typical debugging applications such as real time monitoring of the system state 10, offline analysis for the creation of a complete data memory image using module 11, flash-download by way of communication channel 12 (programming of the program memory), parameter variation during the operation of the embedded system, transmission of system stimuli, rapid prototyping, and hardware-in-the-loop simulation.

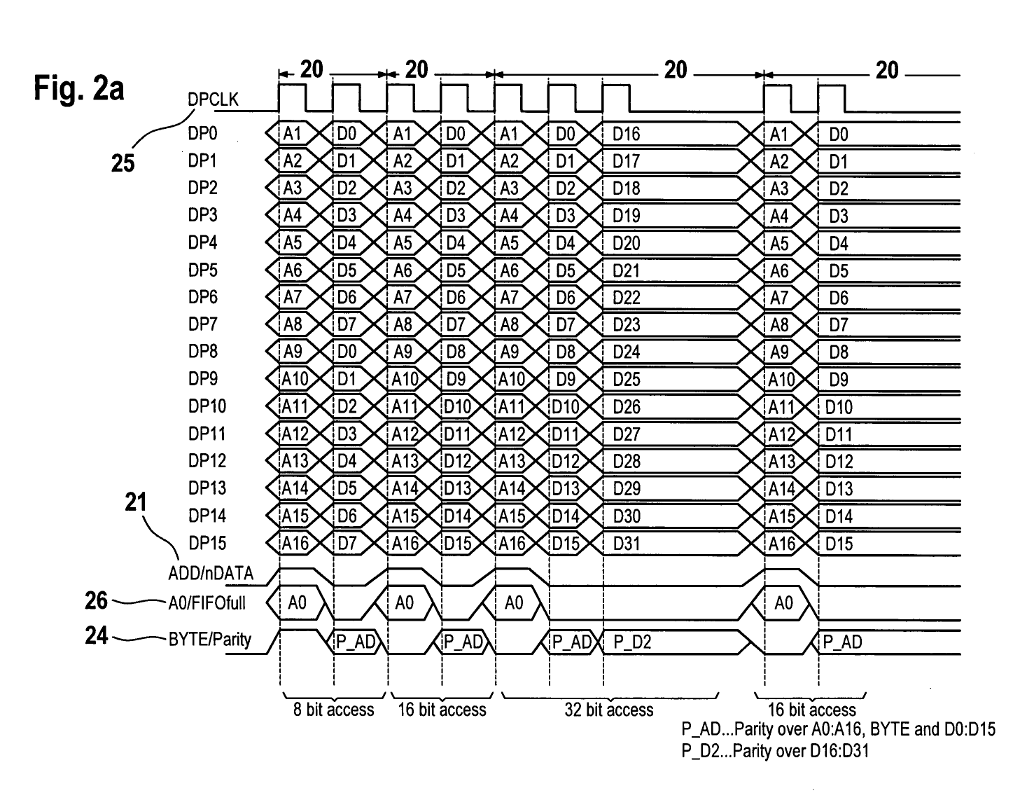

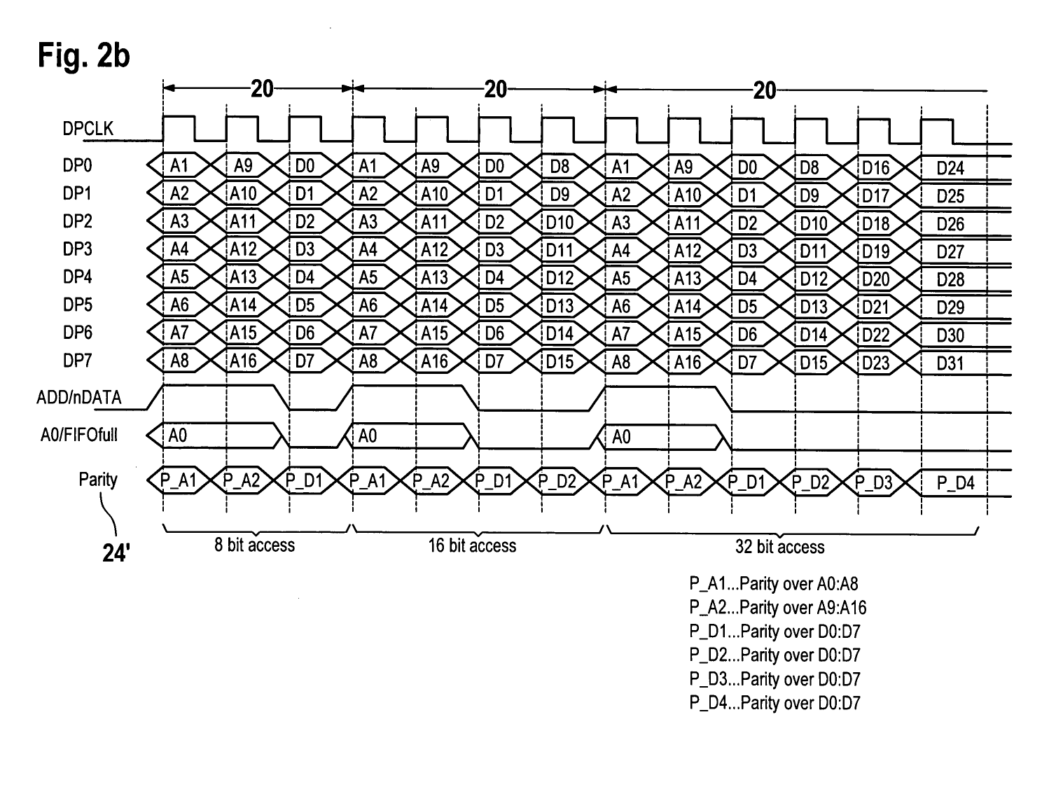

FIG. 2a) shows an example for a pin allocation and a timing diagram of the test interface 5 with a width of the port of 16 bit. In a write access to RAM 3, a package of addresses and data 20 is transmitted which, depending on the desired band width, is always composed of 16 address bits (A1 to A16), followed by data bits D0 to D7 or D0 to D15 or D0 to D31, respectively. The maximum data word width can adopt the values 8, 16, 32, 64, etc.

One or more other lines can favorably be provided as lines to transmit additional address bits, if more than 64 kilobyte shall be addressed. In this case, the illustrated 16 physical lines DP0 to DP15 are not sufficient to transmit the necessary number of address bits. The addressable range is doubled in each case by one or more additional physical lines 26 (pin A0/FIFO full) that transmit additional address information. Due to the port width of 16 pins in partial image a), which is predefined as an example, a maximum address space of 2¹⁷ (128 kilobyte) will thus be achieved.

The length of the address/data phase is favorably indicated using an Add/nDATA line 21, which is provided in the interface and, for example, adopts a logical ‘high’ level during the address phase and a ‘low’ level during the data phase. This way a rising edge of this signal will mark the start of a new data package.

Another line 25 is favorably provided in order to indicate valid data by way of a flank of pin DPCLK. As this occurs, either a rising or a falling edge can be taken into account as a decisive validity criterion.

In the example of the 16-pin wide data port, 16 bits are simultaneously transmitted in parallel. To realize a byte-access (8-bit), an additional signal line 24 (BYTE/Parity) is advantageously provided, the level of which signals a byte access during the address phase. During the data phase, this line can be used to transmit a parity bit.

FIG. 2b) represents another example for a test interface 5 with a width of only 8 bit. Compared to the example in partial image a), a correspondingly larger number of basic cycles are used to transmit data words of a width of more than 8 bit.

Compared thereto, the byte information at pin 24 can be omitted in a byte access so that only one parity bit is transmitted via pin 24′.

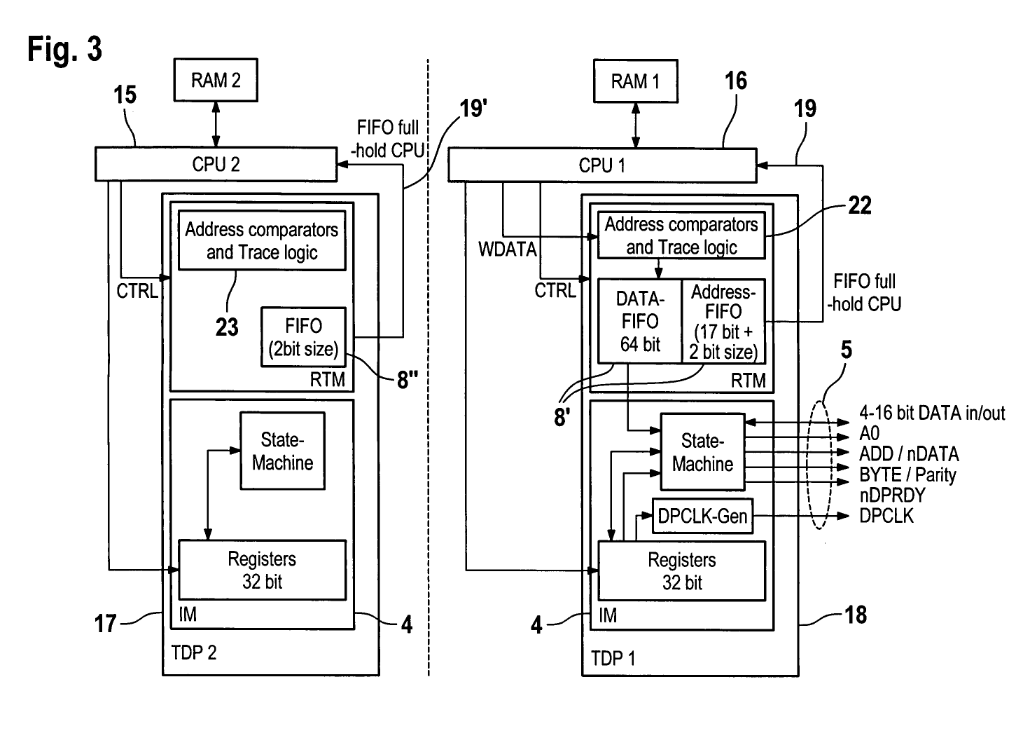

Referring to FIG. 3, a safe microprocessor system for motor vehicles including two CPUs 15 and 16 and respectively one analyzing device 17 and 18 associated with a CPU are schematically illustrated. In comparison with the analyzing device 18, the analyzing device 17 has a reduced scope of functions and, thus, requires chip surface.

In a case of overflow of the FIFO-memory 8′ and 8″ which is provided two times for redundancy reasons, the analyzing devices 17 and 18 will redundantly generate a stop signal in a clock-synchronous manner by way of signal lines 19, 19′ (provided two times), which signal stops the CPUs 15 and 16 until the FIFO-memories 8′ and 8″ have been emptied to a sufficient extent. FIFO-memory 8″ is not complete and therefore has only a data width of 2 (additional) bits. In contrast thereto, FIFO-memory 8′ is a complete memory having a width of 17 address bits, 64 data bits+2 additional bits. The 2 bit wide FIFO-memory 8″ stores only the width of access of the processor. This information is required for the calculation of the basic cycles needed to empty the data-FIFO 19. The microprocessor system comprises two redundant signal lines and analyzing devices to stop the CPUs so that in the event of malfunction of only one analyzing device, the CPU having the functioning analyzing device can continue its operation. Any possible error can be detected as such at a later time by comparing the calculation results or due to stopping of the processor. The redundant Interface Module (IM, TDP2) in the analyzing device 17 does not transmit data on its own. Only the logic 22, 23 for filling and emptying the FIFO-memory must be implemented fully redundantly.

It is advantageous that when employing the above-mentioned multi-core processor architecture, the signal for stopping the CPU can be designed with an appropriate fail-safety, while the chip surface required is reduced. Costs of manufacture are considerably curtailed by using a partly incomplete analyzing device.

As can be shown in the following table, the exemplary analysis port is characterized by a particularly low consumption of basic cycles. In typical examples, a reduction of the operation time is achieved by the test interface of the invention of only 0.5 to 1% approximately with regard to the originally required number of basic cycles. The number of the basic cycles required for the transmission of a data package is indicated in the table:

TABLE

| | |
|---|---|
| Bit width of | Write access width in bit |

| the port | 8 | 16 | 32 | 64 |
|---|---|---|---|---|
| 4 | 6 | 8 | 12 | 20 |
| 8 | 3 | 4 | 6 | 10 |
| 16 | 2 | 2 | 3 | 5 |

1-17. (canceled)

18. An analyzing device for an embedded system (9), comprising:
at least one CPU (1);
at least one CPU bus (2); and
at least one memory (3), including at least one communication module (4) for input or output of analysis data using a test interface (5), wherein the test interface, in addition to control lines, includes at least one group of data lines transmitting data words and address words alternately or in other succession, and information indicating whether data words or address words are transmitted is transmitted by way of at least one control line so that content and access operations during an operation time to a describable internal memory as well as I/O access operations of the embedded system can be monitored or logged practically without using basic cycles of the CPU (1).

19. A device according to claim 18, wherein there are two or more freely selectable analysis modes, with the analysis modes differing from each other in the way and extent of participation of the CPU 1 in reading or writing data for analysis purposes, and wherein depending on the selected analysis mode either all write access operations of the CPU to especially definable address ranges are logged without using basic cycles, or all read access operations of the CPU are logged, or direct reading and writing of the CPU from/into an external memory (6) is executed by using basic cycles.

20. A device according to claim 18, wherein the communication module comprises a logic 22, 23 which independently has access to data or address information through a data connection in order to follow write or read access operations in real time.

21. A device according to claim 18, wherein the communication module is connected to a cache (8, 8′, 8″), and data transmitted in write or read access operations can be stored in the cache, and data out of the cache can be output in a buffered manner through the test interface (5) or data can be written into the cache using the test interface, respectively.

22. A device according to claim 18, wherein the test interface (5) is connected to a test memory (6) arranged outside the embedded system, and the external test memory (6) is especially a central core memory or a dual-port memory.

23. A device according to claim 18, wherein the data transmission from the communication module to the external memory takes place through a parallel interface (5).

24. A device according to claim 18, wherein the external memory (6) is connected to a data conditioning device (7) which provides an interface connection (14) for external debugging applications.

25. A device according to claim 18, wherein the device is in an embedded system which comprises a fully operable microcomputer with at least central processing unit (1) and data memory (3).

26. A device according to claim 18, wherein the device is in an integrated microprocessor system for motor vehicles with at least two processor cores (15, 16), wherein the device is associated with at least one of the processor cores (16) contained therein.

27. A device according to claim 26, wherein that in addition to the first processor core (16) with the complete analyzing device, an incomplete analyzing device (17) is associated with another processor core (15) in the integrated microprocessor system, having a reduced scope of functions compared to the complete analyzing device (18).

28. A device according to claim 27, wherein the reduction of the scope of functions involves that the cache (8′ 8″) provided in the analyzing device has a small number of memory locations and/or a small word width, and/or the test interface (5) is not led to the outside, and/or the test interface (5) does not exist.

29. A method for the analysis of an embedded system with a test interface, the method comprising:
in that for the transmission of data through the test interface, a data transmission protocol is used in which data is transmitted in several groups of addresses and data.

30. A method according to claim 29, wherein at least one mode is provided in which analysis data in real time can be read out of the system which comprises at least CPU, data memory, program memory, and I/O element(s), or can be written into the system, so that the system need not be stopped or interrupted for the analysis.

31. A method according to claim 30, wherein the memory content or a correspondingly assessable information of the embedded system is copied in real time completely or partly into an external memory, with the data being buffered in particular before the action, or the memory content of an external memory (6) or any correspondingly assessable information about the memory content of memory (6) is copied in real time completely or partly into a memory of the embedded system, with the data being buffered in particular before the action.

32. A method according to claim 29, wherein only data necessary for debugging is transmitted to the external memory (6) in the event of access operations of the CPU to RAM 3.

33. A method according to claim 29, wherein write access operations or read access operations of the CPU are logged by means of a cache (8, 8′, 8″).

34. A method according to claim 33, wherein information about the write access operations are written into the cache (8, 8′, 8″) without additional CPU commands or directly into a communication module (4), and information about the read access operations is written into the cache with active assistance of the CPU.
